(19) United States
(12) Patent Application Publication
(10) Pub. No.: US 2023/0255253 A1
(43) Pub. Date: Aug. 17, 2023

(54) SYSTEM AND METHOD FOR PRINTING FOOD PRODUCTS SIMILAR TO ANIMAL MEAT FROM TEXTURED VEGETABLE PROTEIN AND ANIMAL CELL MATERIAL VIA MICRO-EXTRUDING TECHNOLOGY

(71) Applicant: Meal Source Technologies Inc., New York, NY (US)

(72) Inventors: Alexander LEVIN, Moscow (RU); Yusef KHESUANI, Moscow (RU); Alexander OSTROVSKIY, Moscow (RU); Yakov BALAKHOVSKY, New York, NY (US)

(21) Appl. No.: 17/671,239

(22) Filed: Feb. 14, 2022

(51) Int. Cl. A23P 20/20; A23J 3/22; B33Y 10/00; B33Y 30/00; B33Y 50/02

(52) U.S. Cl. CPC A23P 20/20; A23J 3/227; B33Y 10/00; B33Y 30/00; B33Y 50/02; A23P 2020/253

(57) ABSTRACT

Present invention relates to food industry, particularly, to the field of protein-based products as meat substitutes. More particularly, the invention is the system and method for printing food products similar to animal meat from textured vegetable protein and animal cell material via micro-extruding technology. The meat substitute printing system consists of a printing device including a protein material delivery system and a cellular material delivery system of one type at least; a positioning device of the printing device with at least 5 degrees of freedom on various axes and configured to displace the printing device in space as it was preprogrammed, and a control system. The cellular material delivery system has at least one hermetic nozzle that can move along the platform of cellular material delivery system along guiding bars via linear actuator, and protein material delivery system has at least one nozzle that can move along the platform of cellular material delivery system along guiding bars via linear actuator. Plus, nozzle for protein material printing has a reservoir with the material, tip connected with the reservoir, and a heating element that covers at least a part of this nozzle tip and relatively divides its internal space on preheating zone and melt zone, the heating element is configured for uniform heating of melt zone up to the protein denaturation temperature or higher. The control system is configured to issue commands on the positioning device to move the printing device in space, to issue commands on the actuator of each nozzle of the cellular and protein material delivery systems for implementing consistent delivery of each material to the printing surface, to maintain the amount of delivered material and printing speed as it was preprogrammed; to control the temperature of heating element in protein material printing system for textured protein printing. The printing process can take place in the following way: applying a layer of parallel fibers of textured protein, applying a layer of cellular material, then the cycle is repeated. Use of this invention allows to create meat substitute similar in organoleptic and mechanical properties to natural meat from vegetable protein and cellular material of animal origin.

### FIELD OF THE INVENTION

Present invention relates to food industry, particularly, to the field of protein-based products as meat substitutes and custom-made food products.

### BACKGROUND OF THE INVENTION

Technologies of alternative meat products manufacturing has experienced rapid growth in recent decades.

The increasing number of manufacturers state that plant products are appropriate substitute for natural meat. Though, for example, the existing artificial meat from Impossible Foods and Beyond Meat companies (US2019037893, U.S. Ser. No. 11/019,836) is more like mince by its structure. It is not yet possible to recreate the texture of solid piece of meat with raw plant materials.

The most promising alternative to natural meat is cultured meat. Its production involves the creation of large amount of biomass (mainly animal muscle cells with fat cells, etc.) from small amount of cellular material in vitro. All steps of the cultured meat production process can be divided in 4 stages:

1) cell line preparation,

2) cells growth in bioreactor,

3) muscle structures creation,

4) final product.

There are many startups covering various aspects of cultured meat production technology. Several companies specializing in the cell lines preparation, cell culture media development, scaffolds manufacturing, and bioreactor systems design can be distinguished: Roslin Technologies, Lab Farm Foods, Core biogenesis, Tantti BioScaffold, Incuvers. However, it is necessary not only to create muscle fibers, but also to add elements of connective and fat tissues, vessels, and blood to the construct to give cultured meat organoleptic features similar to natural meat.

Companies combining various aspects of cultured meat production technology can be distinguished. Israeli company Aleph Farms stands out among them. It focuses on the creation of cow meat imitation with various cell's types (muscle, connective, fat). Aleph Farms claims that its technologies allow several types of cells to merge into one complex form. This is one of the main obstacles in the development of products from the “cultured meat” category similar organoleptically to natural meat.

Nowadays, neither plant-based meat, nor cultured meat can completely replace natural meat in terms of composition, taste and organoleptics. Thus, several companies have begun to work on the creation of hybrid product that will include both animal cells and vegetable protein. Thereby, hybrid meat will combine the advantages of plant products (high fiber content, low cost of raw materials, simple texture imitation for some meat product types) and cultured meat (use of various cell's types from natural meat, composition similar to natural meat in terms of amino acids, vitamins and micro-elements). This approach allows to respond to consumers' inquiries on healthy, environmentally friendly, and ethical product that also has the taste and structure typical for natural meat.

It should be noted that 3D bioprinting can be used to create products in food industry. The key advantage of 3D bioprinting technology is the opportunity to create complex geometrical figures such as scaffolds for cultured meat.

WO2021/095034 A1 describes the manufacturing of meat substitutes via digital printing. In this regard material containing protein is introduced into digital printer head, then the printer should be controlled to supply the printer platform with single folded protein chain or with multiple separate chains.

US2016135493-A1 discloses automated printing (via vegetable proteins) of food products using additive technologies and 3D printer with replaceable nozzles. The nozzles are chosen according to the custom design printed without human involvement. The printing system includes multiple nozzles holders with the integrated mark (code) that are arranged with an option to remove or install them; multiple stations for dissectible holding of nozzle holders; sensor for determining whether the station is occupied or free; marks reader for extracting information from it; tool moving the stations to different coordinates in X-Y plane. Moreover, this system is bulky, it does not allow to print both cellular and protein materials simultaneously, and it does not allow to print materials at various angles.

Thus, all existing technologies of alternative meat products manufacturing cannot fully satisfy the consumer both in terms of composition and taste. Therefore, there is still a need to develop technologies that will allow us to produce products with organoleptic and mechanical properties close to natural meat.

### SUMMARY OF THE INVENTION

Present invention relates to development of system and method for printing food products similar in organoleptic and mechanical properties to animal meat.

The technical result of present invention is to create the meat substitute equivalent in organoleptic and mechanical properties to animal meat from vegetable protein and cellular material of animal origin via micro-extruding technology.

One aspect of the present invention provides the meat substitute printing system consists of a printing device (1) including a protein material delivery system (3) and a cellular material delivery system (2) of one type at least; a positioning device (5) of the printing device (1) with at least 5 degrees of freedom on various axes and configured to displace the printing device (1) in space as it was preprogrammed, and a control system; the cellular material delivery system (2) has at least one hermetic nozzle (6) that can move along a platform (11) of the cellular material delivery system along guiding bars via linear actuator, the protein material delivery system (3) has at least one nozzle (7) that can move along the platform (10) of the protein material delivery system along guiding bars via linear actuator; moreover, nozzle (7) for protein material printing has a reservoir (14) with the material, a nozzle tip (12) connected with the reservoir (14), and a heating element (13) that covers at least a part of this nozzle tip (12) and relatively divides its internal space on preheating zone (16) and melt zone (17); the heating element (13) is configured for uniform heating of melt zone (17) up to the protein denaturation temperature or higher, the control system is configured to issue commands on the positioning device (5) to move the printing device (1) in space, to issue commands on the actuator of each nozzle of the cellular and protein material delivery systems for implementing consistent delivery of each material to the printing surface (8); to maintain the amount of delivered material and printing speed as it was preprogrammed; to control the temperature of heating element (13) in protein material printing system for textured protein printing.

In some embodiments, the positioning device (5) is presented as robotic arm.

In some embodiments, the heating element is presented as metallic or ceramic element with applied voltage.

In some embodiments, the system includes additional electric source for generating an electric field affecting the printed protein fiber coming out the nozzle tip.

In some embodiments, the nozzle tip for protein material delivery is configured to withstand pressure of 30 atm.

In some embodiments, a nozzle tip for cellular material delivery is presented in the form of a needle with a diameter from 32 G to 16 G.

Another aspect of the present invention provides the meat substitute printing method via the mentioned above system consists of the following stages:
protein and cellular materials are delivered to nozzles for printing of cellular and protein material,
select the movement type for the printing device according to the required mechanical properties of a construct of the meat substitute via the control system user interface
select the speed and amount of delivered protein and cellular material according to the required mechanical properties of the construct via the control system user interface,
select the required nozzle for movement in space at a certain point in time, and movement speed via the control system user interface,
control the temperature of the heating element of the protein material printing nozzle to implement textured protein printing,
implement layer-by-layer delivery of textured protein parallel fibers and cellular material, then the delivery cycle is repeated.

The temperature of the heating element of the protein material printing nozzle is controlled in two stages:
voltage is applied to the heating element so preheating zone (16) and melt zone (17) are heated to the temperature when the protein becomes liquid to pass through the nozzle tip but not denatured yet,
the voltage on the heating element is increased to scale-up the temperature in the melt zone (17) up to the protein material denaturation temperature after the material delivery becomes constant.

### BRIEF DESCRIPTION OF THE DRAWINGS

The features of the invention will become clearer from the following detailed specification with references to the attached figures:

FIG. 1 shows the scheme of the printing device.

FIG. 2 shows schematically the block diagram for the control system.

FIG. 3 shows the tip for the material delivery.

FIG. 4 shows a fiber with different mechanical properties.

FIG. 5 shows the example of the resulting construct with inclined fibres.

### DETAILED DESCRIPTION OF THE INVENTION

The present invention generally describes the system and method for printing food products similar in organoleptic and mechanical properties to animal meat from vegetable protein and cellular material of animal origin. Protein printing together with cell material is carried out via micro-extruding technology with printing head.

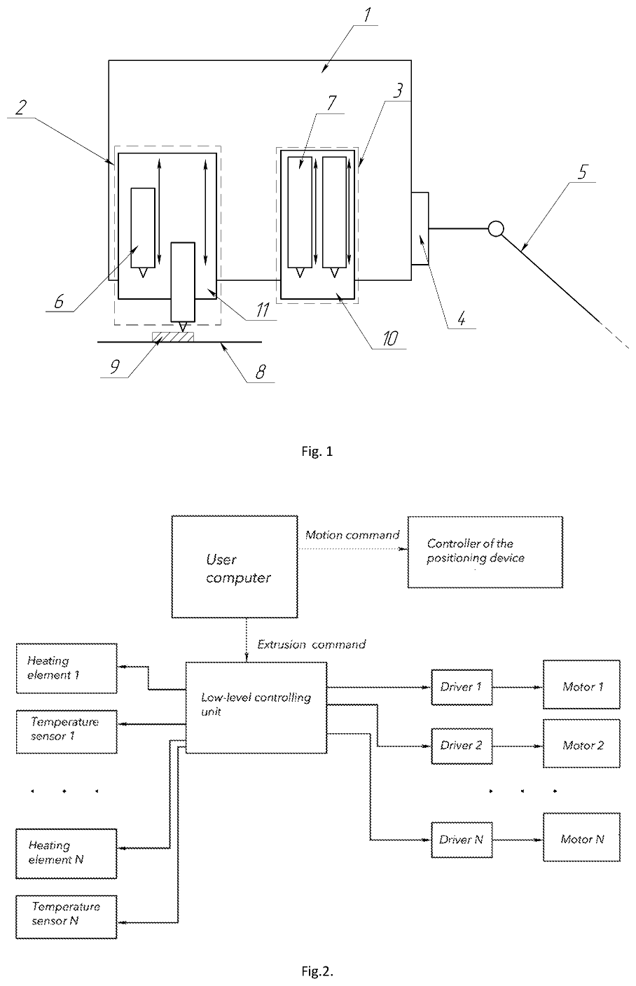

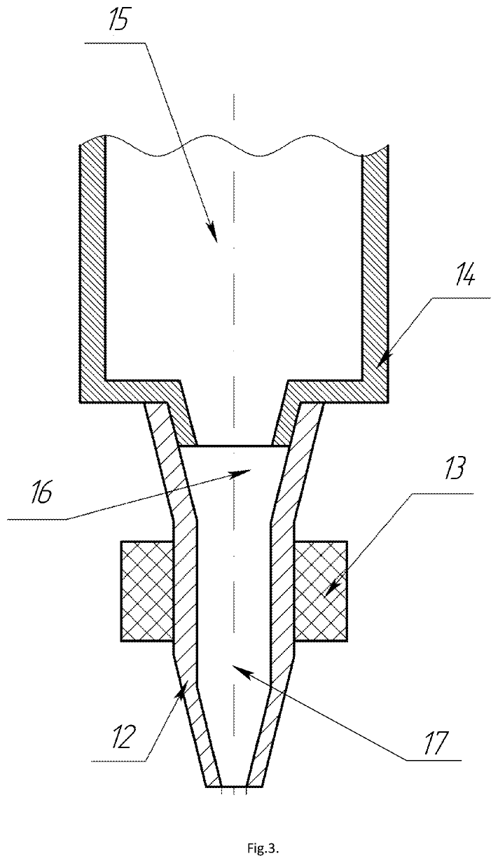

The printing system consists at least of a control system (FIG. 2), a printing device (FIG. 1), and a positioning device of the printing device (printing head) in space, that is implemented in the form of an actuator (5) (manipulator) with several degrees of freedom, and a reprogrammable control unit for performing motion and control functions during the process. The manipulator (5) (schematically shown in FIG. 1) can be presented as a robotic arm that has wide angles of rotation and at least six degrees of freedom (thus, it is possible to achieve precise positioning) or as any other device having more than 5 degrees of freedom on various axes. KUKA LBR IIWA 14 R820 articulated collaborative robot, six-axial robot M-1 iA/0.5AL, five-axial vertical machining center Haas VF-2TR with numerical control can be used as the positioning devices for the printing head.

Using the positioning platform with 5 or more axes and heterogeneous material (on its mechanical properties) extruding via micro-extruding technology allows to solve novel problems in food products printing regarding such organoleptic properties as consistency and hardness. It is possible to create a product with complex internal structure by building the fiber in space via the positioning device, in contrast to industrial extruders.

A print surface (8) and a printing object (9) are shown in FIG. 1 for visual demonstration. Printing device:

printing device (FIG. 1) consists of the protein material delivery system (3) and the cellular material delivery system (2). Both systems are installed on a single platform (1) that can be attached to the positioning device (5). This platform (1) has attachment (4) to link it to the last segment of the positioning device (5). Attachment (4) is configured to provide rigid mechanical bond between the last segment of positioning device (5) and the platform (1). The attachment (4) can be positioned at any location to the platform (1).

In one embodiment, the attachment can be presented in the form of special attachment flange. For example, the flange can have four equally apart openings for M6 screws with 50 mm diameter to attach the platform to the collaborative robot KUKA LBR IIWA 14 R820. The flange may have different design depending on the type of positioning device.

The positioning device (5) moves the platform (1), and respectively the entire printing head (1) together with the material delivery systems (2, 3) in space as it was preprogrammed.

Cellular material delivery system (2):

Cellular material delivery system (2) may include one or more nozzles (6) installed on the platform (11) of the cellular material delivery system that in turn is attached to the platform 1. If several types of cellular material must be printed simultaneously, the preferred embodiment is mobile nozzles (6) (this embodiment is shown in FIG. 1). Thus, each nozzle (6) is installed on guiding bars (sliding/rolling) that are attached to the platform (11) of the cellular material delivery system with an option to move it via linear actuator installed on the same platform. So the nozzle (6) moves on the platform (11) of the cellular material delivery system along the axis of linear actuator movement.

The linear actuator is a device that has a stationary part attached to the platform of the cellular material delivery system (11) and a moving part with one of the cellular material extruders (one of the nozzles) attached. This moving part can move about the stationary part along one axis in both directions. The linear actuator has leads for voltage supply to perform such movements: the movement in one side is implemented via supplying voltage of one force, in another side—via supplying reverse voltage. Alternatively, the actuator may have its own power supply system and interface (UART, TCP/IP, UDP, 12C) for signal pickup determining where it should move.

The sterility of each nozzle (6) must be maintained for printing with cellular material. Hermetic nozzle (6) made of, for example, plastic and aluminum, while all the gaps between the parts should be filled with rubber sealing, must be used to achieve it.

Cellular material extruder (cellular material printing nozzle) consists of a reservoir with cellular material, a tip, and a device for the material delivery to the nozzle tip.

The device for the material delivery to the nozzle tip can be piston, pneumatic, screw, etc. The requirement for such device is to implement the release of the required amount of material from the nozzle according to the program. In some embodiments, various food supplements can be used in addition to the cellular material. The cellular material delivery device can be additionally equipped with temperature support system if the cells require to maintain certain temperature.

The needle with diameter from 32 G to 16 G can be used as the nozzle tip for cellular material delivery. Such needle is used for precise metering of fluid.

Protein material delivery system (3):

Protein material delivery system (3) may also consist of one or more protein material supply nozzles (7) mounted on the platform of the protein material delivery system (10). The vegetable protein material may have different properties depending on its composition. Combination of these materials will allow to create complex heterogeneous structures that are as close to natural or desired as possible. The nozzles (7) in the preferred embodiment are mobile (this embodiment is shown in FIG. 1). For this purpose, each nozzle (7) is installed on guiding bars (sliding/rolling) that are attached to the platform of the cellular material delivery system (10) and fixed on it with the possibility to move via linear actuator. The platform design can be similar to extruders (nozzles) for cellular material printing or differ in the element's sizes.

Protein material extruder (protein material printing nozzle) consists of a reservoir (14) with the material (15), a heater head (13), a tip (12), and a device for the material delivery to the nozzle tip.

The material (15) is initially deployed in special reservoir (14). The device for the material delivery to the nozzle tip (not shown in figures) can be piston, pneumatic, screw, etc. The requirement for such device is to implement the release of the required amount of material from the nozzle according to the program.

The protein material printing nozzle (7) is specially modified for printing with vegetable protein. It has reinforced tip and device for the material delivery as higher magnification for extrusion is required. For example, the nozzle tip and device for the material delivery are configured to withstand pressure of 30 atm.

The nozzle tip (12) is a metal part that can be attached to the reservoir with material (14) as indicated in FIG. 3. The nozzle tip is a replaceable element, and it can be selected for certain material according to its type, required speed, fiber thickness and other factors. Selection of the required nozzle (12) can be performed both automatically and empirically. In the latter, it is possible to control whether the protein material is extruded from the nozzle at the desired speed or not. Otherwise, it is necessary to select a nozzle tip with large diameter. Nozzle tip is installed immediately before printing. The diameter of the nozzle tip (12) can range from 0.1 mm to 1 mm. The diameter of the protein material printing nozzle (12) does not correlate with the diameter of the cellular material printing nozzle.

There are several points in the printing process of parallel fiber layer of textured protein, especially protein that has denatured and taken the shape and direction according to the nozzle tip direction. So, the main challenge is that the protein must be denatured at the nozzle tip end. Though, if the protein passage speed is too low, the protein will denature in the nozzle channel itself and the nozzle tip will clog and fail. If the protein is too high, the protein will not enough time to denature, and the product will not be ready.

This invention uses the algorithm for maturation of micro-extrusion of denatured protein to solve this problem. Protein denaturation is performed by heating (for example, the protein with denaturation temperature of 130 C is used in one embodiment).

In this regard, at least a part of the nozzle tip (12) is surrounded by the heating element (13) that relatively divides the nozzle tip internal space (12) on preheating zone (16) and melt zone (17). The temperature in preheating zone (16) and melt zone (17) is kept constant.

However, zones (16) and (17) are firstly heated up to the temperature when the protein becomes liquid to pass through the nozzle tip but not denatured yet to implement the maturation of micro-extrusion of the denatured protein. Then, as the material delivery is constant, the temperature is scaled-up to the operating level (the protein material denaturation temperature) until the typical structure of the denatured protein can be observed.

Thus, the heating element (13) is configured to heat the zone (17) up to the temperature capable to change the structure of the delivered protein material. Importantly, the zone (17) should be heated smoothly to the protein denaturation temperature or higher (90-150 C). Temperature affects the protein denaturation, that consequently affects the protein mechanical properties.

The heating element (13) is a metallic or ceramic element that is heated due to applied voltage. The heating element must be in front of the nozzle tip and can completely or partly cover it.

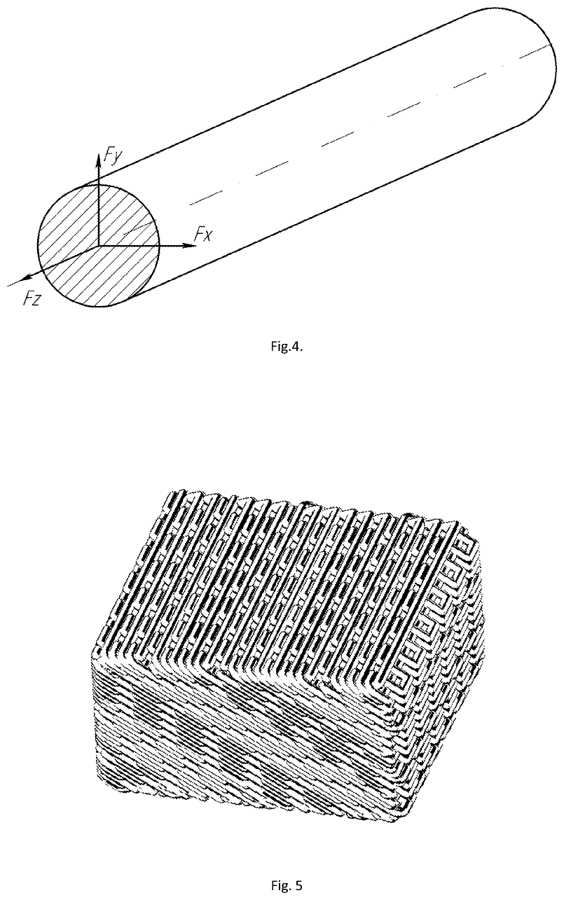

Protein denaturation occurs in the melt zone (17). The micro-extrusion of denatured protein has some peculiarities: the fiber coming from the protein material delivery system has different mechanical properties on squaring and longitudinal shear since the fiber denatures heterogeneously when passing the heating element. The view of such fiber is shown in FIG. 4. This figure shows that rupture forces along the axes are different. F is the rupture force along the axis indicated in the index. Fz is for the longitudinal shear of the fiber, Fx and Fy—for the squaring shear. It is possible to create food products with the necessary mechanical properties by changing the fibers orientation in space in various ways with reference to the difference in mechanical properties in the fiber itself due to squaring or longitudinal shear.

Electric field can be applied between the current nozzle tip (12) of the protein material printing system and the printing surface (8) during the printing process to create the right direction for protein internal structure in the printed fiber. In case of applying additional electric field on the material delivered from the tip, the fibers will be even more directed along the tip's axis. To achieve it, we can apply voltage between the printing surface (8) and the nozzle tip (12).

The electric source is two electrodes. One electrode is installed next to the nozzle tip (12), the other—on the printing surface (8). Particles sensitive to electric field should be added to the protein material to achieve this effect.

The control system may be presented as microprocessor unit, including PC and single-chip computers. The control system must also have a user interface.

The control system (FIG. 2) consists of at least one personal computer or any other computing device with the user interface and low-level controlling unit that manipulates actuators' motors according to the computer-generated commands. The computer also sends move commands to the controller of the positioning device. The low-level controller sends commands to each heating element of the protein material printing nozzle to control the textured protein printing. A temperature sensor is used as backlink.

Software generates the program code that contains commands on:
protein and cellular material printing nozzle tip movement in space,
which nozzle to use at what point in time, what speed to use for nozzles tips.

The software should be located on the same computing device as the user interface, it should calculate the fibers direction according to the required properties, generate the programs for material extrusion and for positioning device movement to adjust the mechanical properties of the printed object. There may be a special function for nozzles replacement. It would replace nozzles in most optimal way in terms of time and material consumption.

An example of the structure was generated in specialized software for trajectory generation (coordinate system SprutCAM), it is shown in FIG. 5. Initial data for trajectory generation is construct mechanical characteristics (hardness, tensile strength, elasticity, toughness). Then the fibers direction and nozzle tip orientation in space can be calculated.

The extrusion speed is determined by the maximum possible extrusion speed of the protein or cellular material that primarily depends on the pressure force on the material delivery system, on the diameter of nozzle tip, as well as on the material toughness.

It is also possible to select where and how many cells can be placed and be added during the printing process. The user assigns how much material should be at what place. Special software calculates where and how much material to extrude.

The printing process can take place in the following way: applying a layer of parallel fibers of textured protein, applying a layer of cellular material, then the cycle is repeated. Single printing head (nozzle) with protein material should be used during the printing process. Moreover, if the program requires to print the area with another protein material, the current head (nozzle) goes up and another one (required) goes down, so the printing process continues with another material. The textured protein refers to protein that has denatured and taken the shape and direction according to the nozzle tip direction.

Layers of protein material and cellular material are applied gradually. One layer is applied first, then next one. This method enables to achieve equal distribution of the cellular material in the construct. If the cellular material is applied in any other way, it will be distributed unevenly.

Use of this method and device allows to print food products similar in organoleptic and mechanical properties to natural meat from vegetable protein and cellular material of animal origin. Use of cellular material allows to enhance taste, protein, and amino-acid value.

1. A meat substitute printing system consists of:
a printing device including a protein material delivery system and a cellular material delivery system of one type at least,
a positioning device of the printing device with at least 5 degrees of freedom on various axes and configured to displace the printing device in space as it was preprogrammed, and
a control system,
moreover
the cellular material delivery system has at least one hermetic nozzle, that can move along a platform of the cellular material delivery system along guiding bars via linear actuator,
the protein material delivery system has at least one nozzle that can move along a platform of protein material delivery system along guiding bars via linear actuator; moreover, nozzle for protein material printing has
a reservoir with the material,
a nozzle tip connected with the reservoir
and a heating element, that covers at least a part of said nozzle tip and relatively divides its internal space on preheating zone and melt zone; the heating element is configured for uniform heating of melt zone up to the protein denaturation temperature or higher,
the control system is configured to issue commands on the positioning device
to move the printing device in space,
to issue commands on the actuator of each nozzle of the cellular and protein material delivery systems for implementing consistent delivery of each material to the printing surface,
to maintain the amount of delivered material and printing speed as it was preprogrammed,
to control the temperature of heating element in the protein material printing system for textured protein printing.

2. The system of claim 1 wherein the positioning device is presented as robotic arm.

3. The system of claim 1 wherein the heating element is presented as metallic or ceramic element with applied voltage.

4. The system of claim 1 wherein the system includes additional electric source for generating an electric field affecting the printed protein fiber coming out the nozzle tip.

5. The system of claim 1 wherein the nozzle tip for protein material delivery is configured to withstand pressure of 30 atm.

6. The system of claim 1 wherein a nozzle tip for cellular material delivery is presented in the form of a needle with a diameter from 32 G to 16 G.

7. A meat substitute printing method via the system from claim 1 consists of the following stages:
protein and cellular materials are delivered to nozzles for printing of cellular and protein material,
select the movement type for the printing device according to the required mechanical properties of a construct of the meat substitute via the control system user interface,
select the speed and amount of delivered protein and cellular material according to the required mechanical properties of the construct via the control system user interface,
select the required nozzle for movement in space at a certain point in time, and movement speed via the control system user interface,
control the temperature of the heating element of the protein material printing nozzle to implement textured protein printing,
implement layer-by-layer delivery of textured protein parallel fibers and cellular material, then the delivery cycle is repeated.

8. The method of claim 7 wherein the temperature of the heating element of the protein material printing nozzle is controlled in two stages:
voltage is applied to the heating element so preheating zone and melt zone are heated to the temperature when the protein becomes liquid to pass through the nozzle tip but not denatured yet,
the voltage on the heating element is increased to scale-up the temperature in the melt zone up to the protein material denaturation temperature after the material delivery becomes constant.
